(19) United States
(12) Patent Application Publication
(10) Pub. No.: US 2011/0258690 A1
(43) Pub. Date: Oct. 20, 2011

(54) SECURE HANDLING OF IDENTIFICATION TOKENS

(75) Inventors: Marc Gaffan, Ganey Tikva (IL); Oran Epelbaum, Givat Shmuel (IL); Amir Zilberstein, Moshav Yad-Rambam (IL); Lior Frenkel, Misgav Dov (IL)

(73) Assignee: HUMAN INTERFACE SECURITY LTD., Rosh HaAyin (IL)

(21) Appl. No.: 13/132,931

(22) PCT Filed: Nov. 29, 2009
(86) PCT No.: PCT/IB09/55396

§ 371 Date: Jun. 6, 2011

Related U.S. Application Data
(60) Provisional application No. 61/144,194, filed on Jan. 13, 2009.

(51) Int. Cl. G06F 21/24

(52) U.S. Cl. 726/9

(57) ABSTRACT

A method for authentication includes, in a first computer (14), receiving from a second computer (16) over a net-work (18) a communication containing an identification token. At the first computer, the identification token is stored only in a memory (30) of an information protection device (20), which is connected to the first computer by a local interface (34).

### CROSS-REFERENCE TO RELATED APPLICATION

This application claims the benefit of U.S. Provisional Patent Application 61/144,194, filed Jan. 13, 2009, whose disclosure is incorporated herein by reference. This application is related to PCT Patent Application PCT/IL2008/001187, filed Sep. 3, 2008, which is assigned to the assignee of the present patent application and whose disclosure is incorporated herein by reference.

### FIELD OF THE INVENTION

The present invention relates generally to information security, and specifically to devices and methods for enhancing the security of data communications.

### BACKGROUND OF THE INVENTION

Computing applications often use identification tokens for authenticating users and user computers. An identification token typically comprises an object, which is stored on a computer by a program such as a web browser, so as to enable the program to authenticate the computer. Examples of identification tokens include tracking cookies, browser cookies, and HTTP cookies (all referred to herein as “cookies”). A cookie may comprise, for example, one or more name-value pairs containing bits of information such as user preferences, shopping cart contents, an identifier for a server-based session, or other data used by web sites. Another example is a Flash™ object, which may be used for storage and retrieval of tokens.

In some client/server communication protocols, the server (also referred to herein as a “remote computer”) may send an identification token for storage by the client. In subsequent communications, the client (also referred to herein as a “local computer”) may be required to return the identification token to the server for the purpose of authentication. The server may generate the token in a way that uniquely identifies the client, and may periodically change the token and/or digitally sign the token to enhance the security of authentication.

Nevertheless, identification tokens of this sort may be intercepted and used by malicious parties to circumvent the server's authentication mechanisms. For example, a Trojan horse program running on the client computer may copy and transfer a token to another computer, or may otherwise tamper with the information in the token. If the token is successfully transferred to another computer, the server may then identify that computer as the original client. (In some cases, the malicious user may have to use the stolen token in combination with other authentication and/or identification information, such as a username and password, which may likewise be misappropriated by the malicious user.)

### SUMMARY OF THE INVENTION

An embodiment of the present invention provides a method for authentication, including:

in a first computer, receiving from a second computer over a network a communication containing an identification token; and

at the first computer, storing the identification token only in a memory of an information protection device, which is connected to the first computer by a local interface.

In some embodiments, the identification token stored in the memory of the information protection device is inaccessible to software running on the first computer. In a disclosed embodiment, the second computer includes a server, and the first computer includes a client computer served by the server. In an embodiment, receiving the communication includes configuring the first computer to route the communication via the information protection device. In another embodiment, the method includes establishing a secure logical path through the first computer between the information protection device and the second computer, and transmitting the identification token over the secure logical path.

In some embodiments, receiving the communication includes:

receiving, by the information protection device, a first communication, which contains the identification token and is directed from the second computer to the first computer;

removing, by the information protection device, the identification token from the first communication, to produce a second communication;

storing the identification token removed from the first communication in the memory of the information protection device; and

conveying, by the information protection device, the second communication to the first computer.

In another embodiment, the method includes:

receiving, by the information protection device, a first communication that is directed from the first computer to the second computer and is to carry the identification token;

retrieving, by the information protection device, the identification token from the memory of the information protection device;

adding, by the information protection device, the identification token to the first communication, to produce a second communication; and

conveying the second communication to the second computer.

In some embodiments, the local interface includes a detachable connection, and the method includes connecting the information protection device to the first computer temporarily before exchanging the communication. In an embodiment, the identification token includes a cookie. In an embodiment, the local interface includes a wired connection. The wired connection may include a Universal Serial Bus connection. Alternatively, the local interface includes a wireless connection. The wireless connection may include one of a Bluetooth connection, an infrared connection and a radio connection. In a disclosed embodiment, the information protection device is integrated in the first computer. In an embodiment, the second computer includes a web server. In another embodiment, the first computer includes one of a mobile telephone and a personal digital assistant. In an embodiment, the network includes at least one network type selected from a group of types consisting of a cellular network, a LAN, a WAN and the Internet.

There is additionally provided, in accordance with an embodiment of the present invention, an information protection device, including:

a local interface for connection to a first computer;

a memory; and

a processor, which is configured to store in the memory an identification token that is received in the first computer from a second computer over a network, and to exchange the identification token with the first computer over the local interface when exchanging communication between the first computer and the second computer.

In some embodiments, the memory includes at least one memory type selected from a group of types consisting of a volatile memory and a non-volatile memory.

There is further provided, in accordance with an embodiment of the present invention, a system for authentication, including:

an information protection device including a memory and a local interface; and

a first computer, which is connected to the information protection device using the local interface and is configured to receive from a second computer over a network a communication containing an identification token, and to store the identification token only in the memory of the information protection device.

### BRIEF DESCRIPTION OF THE DRAWINGS

The disclosure is herein described, by way of example only, with reference to the accompanying drawings, wherein:

FIG. 1 is a schematic pictorial illustration of a system for secure data communications, in accordance with an embodiment of the present invention;

FIG. 2 is a block diagram that schematically shows components of an information protection device, in accordance with an embodiment of the present invention;

FIG. 3 is a flow diagram which schematically illustrates a secure server to client communication method, in accordance with an embodiment of the present invention;

FIG. 4 is a flow diagram which schematically illustrates a secure client to server communication method, in accordance with an embodiment of the present invention; and

FIG. 5 is a schematic pictorial illustration showing physical and logical communication paths in a secure communication system, in accordance with an embodiment of the present invention.

### DETAILED DESCRIPTION OF EMBODIMENTS

The following notation is used throughout the document:

| Term | Definition |
|---|---|
| HTTP | Hypertext Transfer Protocol |
| HTTPS | Hypertext Transfer Protocol Secure |
| IC | Integrated Circuit |
| LAN | Local Area Network |
| PDA | Personal Digital Assistant |
| PKI | Public Key Infrastructure |
| RAM | Random Access Memory |
| ROM | Read Only Memory |
| SSL | Secure Sockets Layer |
| USB | Universal Serial Bus |
| WAN | Wide Area Network |

### Overview

Embodiments of the present invention that are described hereinbelow provide methods and devices for secure handling of identification tokens, which can help to prevent token theft and tampering, along with the resulting identity theft. In some embodiments, the identification tokens are not stored in the client computer itself (or a memory accessible by the client computer), but rather in a separate information protection device that can be coupled to the client computer temporarily. The identification tokens are not accessible in unencrypted form to the client computer software, thereby preventing any malicious software that may be running on the client computer to access and tamper with the token.

In some embodiments, the user of a client computer connects an information protection device to the client computer by a short-range wired or wireless link before initiating network communication between the client computer and a server. (Alternatively, in other embodiments, the device may be integrated with the computer hardware (i.e., a component of the client computer). The information protection device comprises a processor and a memory, which are secure, in the sense that they are not accessible to the client computer.

In some embodiments, communications between the server and the client computer are routed via the information protection device. The device removes and stores identification tokens that are sent by the server and holds the tokens in the memory. When required, the device transmits the appropriate token back to the server. The client may thus be authenticated to the server, using the token, even though the token is not directly accessible by the client. In other words, the token is never present in clear (unencrypted) form in the memory of the computer itself or available in clear form to the CPU of the client computer.

### System Description

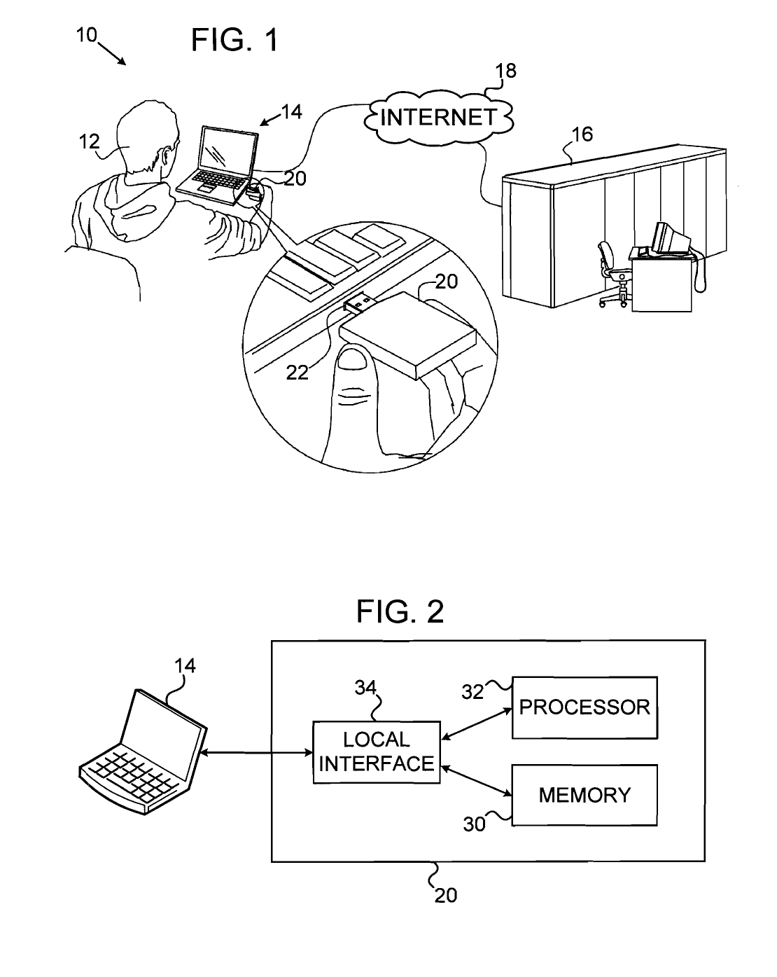

FIG. 1 is a schematic pictorial illustration of a system 10 for secure data communications, in accordance with an embodiment of the present invention. In a typical scenario, a user 12 operates a client computer 14 to establish a communication session with a remote server 16 over a network 18 (e.g., the Internet, a LAN or a WAN). Client computer 14 and remote server 16 are examples, respectively, of a local computer and a remote computer that may be used in this embodiment, but the principles of the present invention may similarly be implemented using any suitable types of computing devices that communicate over substantially any type of network. For example, the “local computer” may comprise a mobile telephone or personal digital assistant (PDA) with suitable computing and communication capabilities, while the network comprises a cellular network.

In preparation for establishing the communication session, user 12 couples an information protection device 20 via a local interface to computer 14. In this case, the local interface comprises a mating receptacle 22, such as a USB port or other detachable connection in computer 14, and the user couples device 20 to computer 14 by making a physical connection with the port. Alternatively, any other suitable sort of local interface may be used, including both wired interfaces (such as the USB or other port) and wireless interfaces, such as a Bluetooth™ or other radio interface or an infrared interface. The term “local” in this context is used to refer to interfaces that operate over short ranges, in the sense that both computer 14 and device 20 are in physical reach of user 12 simultaneously.

In operation of system 10, as described in greater detail hereinbelow, device 20 stores identification tokens to a memory in device 20. The identification tokens stored in device 20 are received from server 16 or any other computer coupled to network 18. Additionally, the tokens can be received from multiple computers on network 18. In one embodiment, which is described in detail hereinbelow, server 16 sends a communication including an identification token over network 18 to computer 14 via device 20. Device 20 removes the identification token and then sends the modified communication (i.e., the original communication from the server without the identification token) to computer 14. On the other hand, when client computer 14 sends a communication over network 18 to server 16, device 20 adds any appropriate identification tokens to the communication sent to the server.

Typically, client computer 14 and server 16 are general-purpose computers, which are programmed in software to carry out the functions that are described herein. This software may be downloaded to the appropriate computer in electronic form, over a network, for example, or it may alternatively be provided on tangible media, such as magnetic, optical or electronic memory media.

FIG. 2 is a block diagram that schematically shows components of information protection device 20, in accordance with an embodiment of the present invention. Although FIG. 2 shows an example of an information protection device with certain specific combinations of features, other information protection devices for use in system 10 may have different combinations and implementations of such features, as will be apparent to those skilled in the art.

Information protection device 20 comprises a secure memory 30, a processor 32 driven by suitable software, and a local interface 34 for coupling to client computer 14. Information protection devices with suitable hardware configurations for this purpose are described, for example, in PCT Patent Application PCT/IL2008/001187, cited above. Alternatively, many existing plug-in memory devices, such as disk-on-key devices, smart cards, USB tokens, PKI tokens, and other identification keys and authentication devices, also often have the required hardware components and may be modified to carry out the functions described herein by addition of suitable software.

Processor 32 operates in accordance with program instructions that are stored in memory 30. Processor 32 may comprise a general-purpose microprocessor or microcontroller device. Additionally or alternatively, processor 32 may comprise a special-purpose processor, such as a reduced-instruction-set computer (RISC).

In some embodiments, memory 30 is configured to store both software (i.e., to be executed on processor 32) and one or more identification tokens. Memory 30 typically comprises either a random access memory (RAM) or a non-volatile (e.g., Flash) memory with an appropriate interface to store both the software and the identification tokens. Alternatively, memory 30 may comprise separate memory modules for the software and the identification tokens. A memory module to store software may comprise a programmable type of ROM, such as Flash ROM, to permit the software to be updated from time to time. The memory module to store identification tokens may comprise either RAM or Flash memory. Alternatively, one or more identification tokens may be pre-loaded into a ROM module for subsequent use by device 20.

Although device 20 is shown in FIG. 2, for the sake of conceptual clarity, as comprising certain distinct functional blocks, the blocks do not necessarily reflect the physical components that are used in actual implementations of the device. Rather, certain blocks may be combined within a single IC component. On the other hand, certain blocks may be implemented using two or more different components. All such implementations are considered to be within the scope of the present invention.

### Secure Authentication

As discussed supra, in embodiments of the present invention, identification tokens are stored in a separate information protection device that can be coupled to the client computer temporarily. Since the identification tokens are not stored in the memory of the client computer, any malicious software that may be running on the client computer will not be able to access and tamper with the tokens.

In order to ensure that identification tokens are captured and held by information protection device 20, and do not reach client computer 14, client software on the client computer is configured to communicate with any relevant server via the information protection device. For example, client computer 14 may be programmed to relate to information protection device 20 as the exclusive gateway to server 16 (for example, via a tunnel, as explained below, or as a network interface). Software for this purpose may be stored on information protection device 20 itself, in such a way as to run automatically on client computer 14 when the information protection device is connected (by wired or wireless link) to the client computer. Processor 32 is programmed to process messages from server 16 so as to recognize, save and remove any identification tokens before passing the messages on to client computer 14. Information protection device 20 likewise processes messages from client computer 14 and adds in the stored identification tokens as appropriate for transmission to server 16. Thus, the server is able to authenticate the client on the basis of the tokens, while the client computer itself does not actually receive the tokens and is unable to access them. As a result, any Trojan horse or other malicious program running on the client computer will likewise be unable to access the tokens.

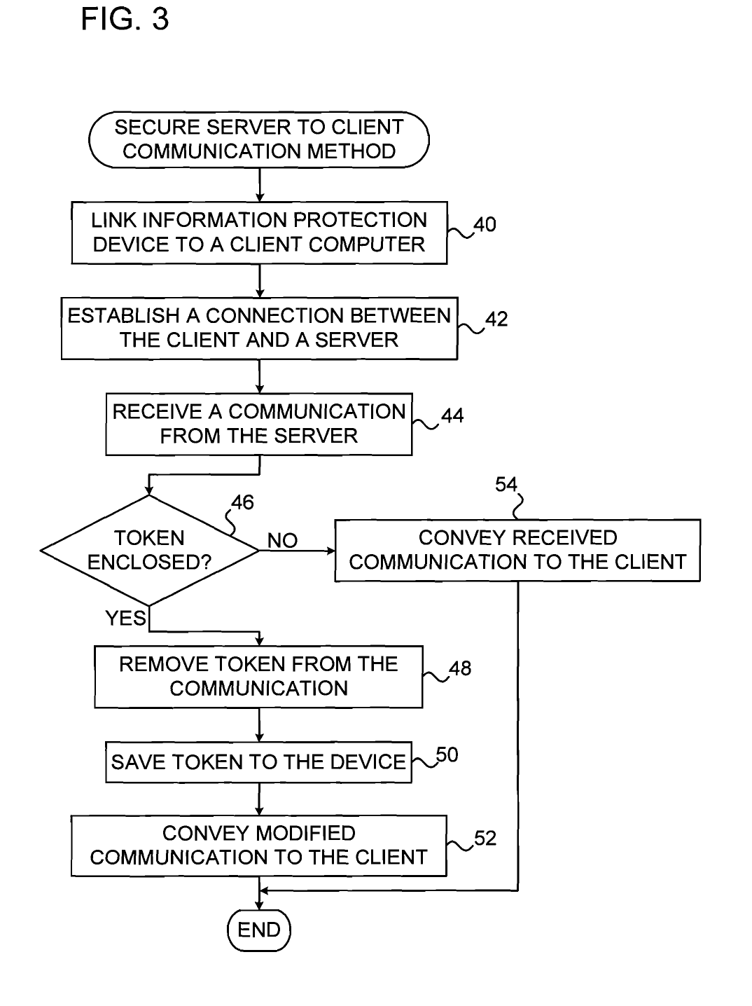

FIG. 3 is a flow diagram which schematically illustrates a secure server to client communication method, in accordance with an embodiment of the present invention. To initiate communications with server 16, user 12 couples information protection device 20 to communicate locally with client computer 14 (step 40). The coupling may take the form of physically plugging the information protection device into the client computer or simply bringing the information protection device into proximity with the client computer so that a short-range wireless link may be established. A suitable driver program is typically pre-installed in client computer 14, which causes the client computer to recognize and interact with device 20 in the appropriate manner during the method steps described below. Alternatively, information protection device 20 may contain a program in memory 30 that runs automatically on client computer 14 when the device is plugged into the computer, so that the computer can interact with the device in the desired manner without previous software installation.

User 12 operates computer 14 to establish a connection with server 16 (step 42) via device 20. For example, the user may navigate to a Web site run by server 16 using a browser program on computer 14. Although the method described in FIG. 3 includes the initial steps of coupling device 20 to client computer 14 (i.e., step 40) and establishing a connection with server 16 (i.e., step 42), the method of FIG. 3 is applicable for any communication sent from the server to the client computer.

After establishing the connection, device 20 receives a communication from server 16 via local interface 34 and stores the communication in memory 30 (step 44). If processor 32 detects an identification token in the received communication (step 46), then the processor removes the identification token from the communication (step 48), and stores the identification token to memory 30 (step 50). Additionally or alternatively, server 16 may include a change (e.g., a digital signature) to an identification token already stored in memory 30. Processor 32 then sends the modified communication (i.e., the received communication without the identification token) to client computer 14 via local interface 34 (step 52).

If, however, the received communication does not contain an identification token (step 46), then processor 32 sends the received communication (i.e., in its entirety) to client computer 14 without modification (step 54). As can be appreciated, the software running on client computer 14 has no access to the identification token throughout the process of FIG. 3.

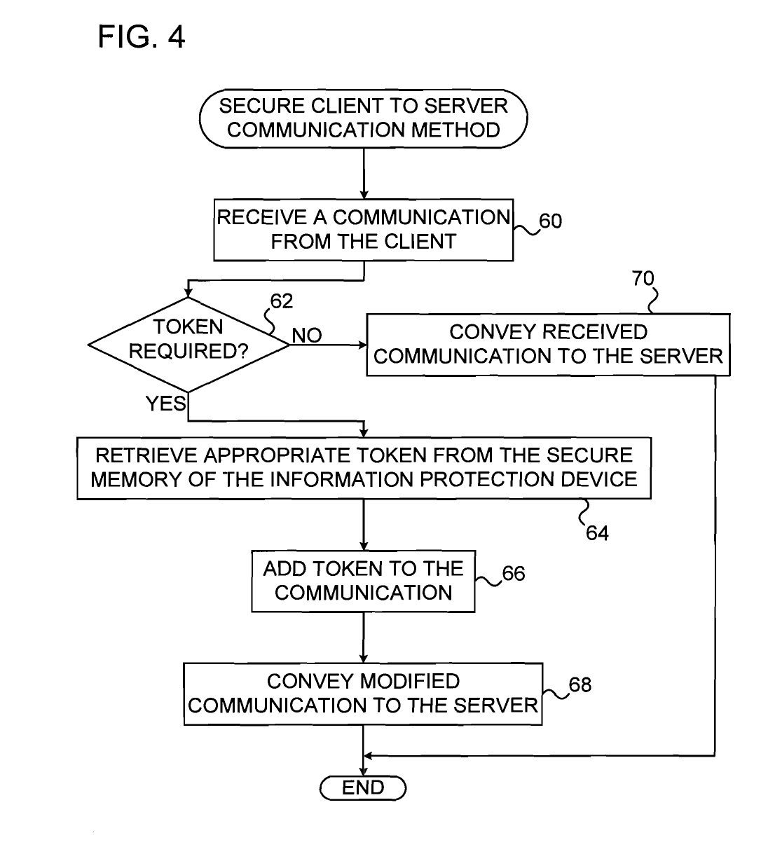

FIG. 4 is a flow diagram which schematically illustrates a secure client to server communication method, in accordance with an embodiment of the present invention. As discussed supra, device 20 stores identification tokens in secure memory 30 in order to prevent any rogue application executing on client computer 14 from compromising an identification token. While the identification token is not stored on client computer 14, there are instances when a communication from the client computer to server 16 will require an identification token (i.e., one stored in memory 30). Additionally or alternatively, there are instances where client computer 14 edits a token stored in memory 30 (e.g., when adding or deleting items from a shopping cart).

Processor 32 receives a communication from client computer 14 via interface 34 (step 60). If processor 32 determines that the communication requires an identification token (step 62), then processor 32 retrieves the appropriate identification token from secure memory 30 (step 64), adds the retrieved token to the communication (step 66), and sends the modified communication (i.e., the received communication plus the identification token) to server 16 via interface 34 (step 68). If however, the received communication is not associated with an identification token, then processor 32 sends the received communication to server 16 via interface 34 without modification (step 70).

The information protection devices described in the above-cited PCT Patent Application PCT/IL2008/001187, and likewise most plug-in memory devices, do not typically have a network interface suitable for communicating directly with a remote server. Instead, the communications model described above, in which client/server communications are routed through the information protection device, may be implemented by secure tunneling of communications through the client computer between the information protection device and the server. In other words, communications between information protection device 20 and server 16 pass physically through client computer 14, but are transmitted in a way that prevents the client computer from accessing the contents of the communications.

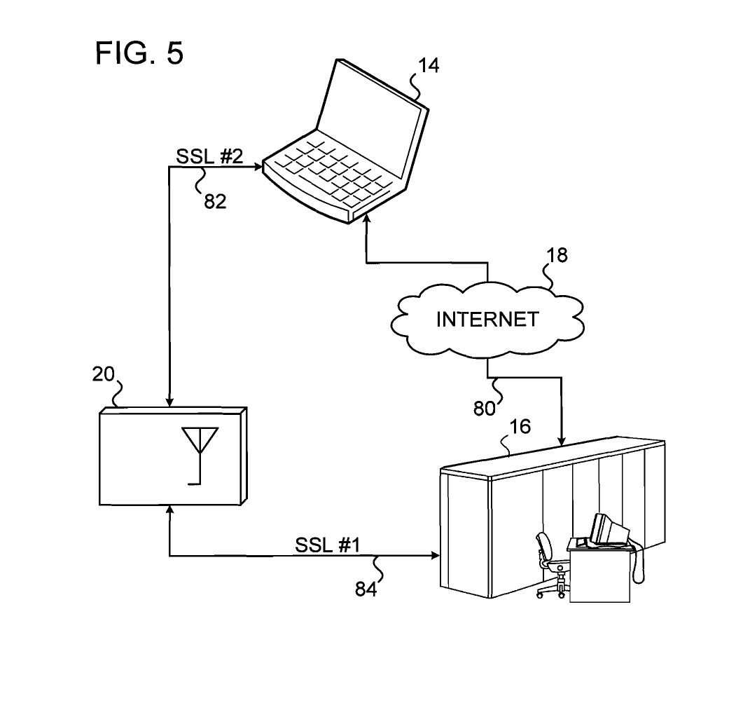

FIG. 5 is a schematic pictorial illustration showing physical and logical communication paths in a secure communication system, in accordance with an embodiment of the present invention. In the present example, communications between information protection device 20 and server 16 are carried over a physical communication path 80 between client computer 14 and server 16 via network 18. In order to convey identification tokens over physical path 80 without exposing the information to computer 14, processor 32 on device 20 opens a secure logical path 84 directly from device 20 to server 16. Although logical path 84 is carried physically via the short-range interface of device 20 to computer 14, and through the computer over physical path 80 to the server, the information transmitted over the logical path is encrypted in a manner inaccessible to computer 14. For example, logical path 84 may comprise a SSL connection between device 20 and server 16, which “tunnels” transparently through computer 14. Computer 14 merely relays the packets transmitted over path 84, without being able to read or alter the higher-level protocol headers and payload data in these packets.

The processor in device 20 typically opens a second logical path 82 between the device and client computer 14 via the short-range interface of the device. The processor then passes information over path 82 for display by client computer 14. Path 82 may also comprise a SSL connection, so that device 20 may serve as a sort of SSL proxy between client computer 14 and server 16. Alternatively, device 20 may communicate with the client over any other suitable sort of logical path, whether secure or non-secure.

As an example of the operation of device 20 in the system configuration shown in FIG. 5, let us assume that server 16 is a secure Web server, which communicates with a browser program running on client computer 14 using HTTPS. The browser program generates an initial HTTPS request directed to the server, and passes the request on to device 20 over path 82. The device relays the request to server 16 over path 84. The server then returns a HTTPS response, containing an identification cookie, over path 84. Device 20 recognizes the cookie in the response, and saves the cookie together with context information (such as the domain name of server 16) in secure memory 30 of device 20. Device 20 strips the cookie from the HTTPS response, or substitutes another cookie, and then passes the response in this form to the client computer browser over path 82.

When the browser on client computer 14 sends its next HTTPS request directed to server 16 over path 82, device 20 recognizes the context of the request. The device accordingly retrieves the original cookie from memory 30, adds the cookie to the HTTPS request, and transmits this request over path 84 to server 16. Server 16 authenticates client computer 14 on the basis of this cookie, and takes the appropriate action. This pattern of interaction may continue indefinitely.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limiting to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It is intended that the appended claims cover all such features and advantages of the disclosure that fall within the spirit and scope of the present disclosure. As numerous modifications and changes will readily occur to those skilled in the art, it is intended that the disclosure not be limited to the limited number of embodiments described herein. Accordingly, it will be appreciated that all suitable variations, modifications and equivalents may be resorted to, falling within the spirit and scope of the present disclosure.

1. A method for authentication, comprising:
in a first computer, receiving from a second computer over a network a communication containing an identification token; and
at the first computer, storing the identification token only in a memory of an information protection device, which is connected to the first computer by a local interface.

2. The method according to claim 1, wherein the identification token stored in the memory of the information protection device is inaccessible to software running on the first computer.

3. The method according to claim 1, wherein the second computer comprises a server, and wherein the first computer comprises a client computer served by the server.

4. The method according to claim 1, wherein receiving the communication comprises configuring the first computer to route the communication via the information protection device.

5. The method according to claim 1, and comprising establishing a secure logical path through the first computer between the information protection device and the second computer, and transmitting the identification token over the secure logical path.

6. The method according to claim 1, wherein receiving the communication comprises:
receiving, by the information protection device, a first communication, which contains the identification token and is directed from the second computer to the first computer; removing, by the information protection device, the identification token from the first communication, to produce a second communication;
storing the identification token removed from the first communication in the memory of the information protection device; and
conveying, by the information protection device, the second communication to the first computer.

7. The method according to claim 1, and comprising:
receiving, by the information protection device, a first communication that is directed from the first computer to the second computer and is to carry the identification token;
retrieving, by the information protection device, the identification token from the memory of the information protection device;
adding, by the information protection device, the identification token to the first communication, to produce a second communication; and
conveying the second communication to the second computer.

8. The method according to claim 1, wherein the local interface comprises a detachable connection, and comprising connecting the information protection device to the first computer temporarily before exchanging the communication.

9. The method according to claim 1, wherein the identification token comprises a cookie.

10. The method according to claim 1, wherein the local interface comprises a wired connection.

11. The method according to claim 10, wherein the wired connection comprises a Universal Serial Bus connection.

12. The method according to claim 1, wherein the local interface comprises a wireless connection.

13. The method according to claim 12, wherein the wireless connection comprises one of a Bluetooth connection, an infrared connection and a radio connection.

14. The method according to claim 1, wherein the information protection device is integrated in the first computer.

15. The method according to claim 1, wherein the second computer comprises a web server.

16. The method according to claim 1, wherein the first computer comprises one of a mobile telephone and a personal digital assistant.

17. The method according to claim 1, wherein the network comprises at least one network type selected from a group of types consisting of a cellular network, a LAN, a WAN and the Internet.

18. An information protection device, comprising:
a local interface for connection to a first computer;
a memory; and
a processor, which is configured to store in the memory an identification token that is received in the first computer from a second computer over a network, and to exchange the identification token with the first computer over the local interface when exchanging communication between the first computer and the second computer.

19. The information protection device according to claim 18, wherein the memory comprises at least one memory type selected from a group of types consisting of a volatile memory and a non-volatile memory.

20. The information protection device according to claim 18, wherein the processor is configured to establish a secure logical path between the first computer and the second computer, and to transmit the identification token over the secure logical path.

21. The information protection device according to claim 18, wherein the processor is configured to receive a first communication, which contains the identification token and is directed from the second computer to the first computer, to remove the identification token from the first communication so as to produce a second communication, to store the identification token removed from the first communication in the memory, and to convey the second communication to the first computer.

22. The information protection device according to claim 18, wherein the processor is configured to receive a first communication that is directed from the first computer to the second computer and is to carry the identification token, to retrieve the identification token from the memory, to add the identification token to the first communication so as to produce a second communication, and to convey the second communication to the second computer.

23. The information protection device according to claim 18, wherein the identification token stored in the memory is inaccessible to software running on the first computer.

24. The information protection device according to claim 18, wherein the local interface comprises a wired connection.

25. The information protection device according to claim 24, wherein the wired connection comprises a Universal Serial Bus connection.

26. The information protection device according to claim 18, wherein the local interface comprises a wireless connection.

27. The information protection device according to claim 26, wherein the wireless connection comprises one of a Bluetooth connection, an infrared connection and a radio connection.

28. The information protection device according to claim 18, wherein the information protection device is integrated in the first computer.

29. The information protection device according to claim 18, wherein the local interface comprises a detachable connection.

30. A system for authentication, comprising:
an information protection device comprising a memory and a local interface; and
a first computer, which is connected to the information protection device using the local interface and is configured to receive from a second computer over a network a communication containing an identification token, and to store the identification token only in the memory of the information protection device.

31. The system according to claim 30, wherein the identification token stored in the memory of the information protection device is inaccessible to software running on the first computer.

32. The system according to claim 30, wherein the first computer is configured to receive the communication from the second computer by routing the communication via the information protection device.

33. The system according to claim 30, wherein the information protection device is configured to establish a secure logical path between the first computer and the second computer, and to transmit the identification token over the secure logical path.

34. The system according to claim 30, wherein the information protection device is configured to receive a first communication, which contains the identification token and is directed from the second computer to the first computer, to remove the identification token from the first communication so as to produce a second communication, to store the identification token removed from the first communication in the memory, and to convey the second communication to the first computer.

35. The system according to claim 30, wherein the information protection device is configured to receive a first communication that is directed from the first computer to the second computer and is to carry the identification token, to retrieve the identification token from the memory, to add the identification token to the first communication so as to produce a second communication, and to convey the second communication to the second computer.
